(19) United States
(12) Patent Application Publication
(10) Pub. No.: US 2020/0159784 A1
(43) Pub. Date: May 21, 2020

(54) INFORMATION PROCESSING APPARATUS, INFORMATION PROCESSING SYSTEM, INFORMATION PROCESSING METHOD, AND METHOD OF DETERMINING SIMILARITY/DISSIMILARITY

(71) Applicant: NABTESCO CORPORATION, Tokyo (JP)

(72) Inventors: Osamu KIKUCHI, Tokyo (JP); Hiroyuki INOUE, Tokyo (JP)

(21) Appl. No.: 16/570,215

(22) Filed: Sep. 13, 2019

(30) Foreign Application Priority Data
Nov. 19, 2018 (JP) 2018-216674

(51) Int. Cl. G06F 16/951; G06F 21/10; G06N 20/00; G06F 16/9536; G06Q 50/18

(52) U.S. Cl. CPC G06F 16/951; G06F 21/10; G06Q 50/184; G06F 16/9536; G06N 20/00

(57) ABSTRACT

An infringement detection apparatus is an information processing apparatus. The infringement detection apparatus stores, in a storage unit, a similarity/dissimilarity determination model produced through machine learning based on a plurality of cases showing determination on similarity/dissimilarity of marks. The infringement detection apparatus acknowledges an input of a second mark that should be compared with a first mark that is a subject of determination. The infringement detection apparatus determines similarity/dissimilarity between the first mark and the second mark by using the similarity/dissimilarity determination model stored in the storage unit.

### CROSS REFERENCES TO RELATED APPLICATIONS

The present application claims priority under 35 U.S.C. § 119 to Japanese Patent Application 2018-216674 filed on Nov. 19, 2018, the entire contents of which being incorporated herein by reference.

### BACKGROUND OF THE INVENTION

### 1. Field of the Invention

The present invention relates to data processing technologies and, more particularly, to an information processing apparatus, an information processing system, an information processing method, and a method of determining similarity/dissimilarity.

### 2. Description of the Related Art

There is proposed a technology whereby a mark similar to a subject mark is produced based on the guideline illustrated in the Trademark Examination Guidelines used in trademark examination in the Japan Patent Office, the web is searched for the similar mark, and information on trademark infringement is acquired by using the result of the search (see, for example, patent literature 1).

[patent literature 1] JP2016-153975

The technology disclosed in patent literature 1 is directed to detecting the likelihood of infringement when the similar mark is used on the web. However, the similar mark is produced based on the guideline for similarity/dissimilarity determination illustrated in the Trademark Examination Guidelines defined for stereotypical trademark examination. We have thought that the guideline is defined stereotypically for trademark examination and is not necessarily suitable for detection of actual cases of infringement of trademark rights, etc.

### SUMMARY OF THE INVENTION

The invention is based on the awareness of the above-described issue, and a purpose thereof is to improve the precision of determination on similarity/dissimilarity of marks adapted to cases of trademark right infringement.

An information processing apparatus according to an embodiment of the present invention includes: a storage unit that stores a similarity/dissimilarity determination model produced through machine learning based on a plurality of cases showing determination on similarity/dissimilarity of marks; an acknowledgment unit that acknowledges an input of a second mark that should be compared with a first mark that is a subject of determination; and a determination unit that determines similarity/dissimilarity between the first mark and the second mark by using the similarity/dissimilarity determination model stored in the storage unit.

Another embodiment of the present invention also relates to an information processing apparatus. The apparatus includes: a first retrieval unit that retrieves a second trademark for which a product or a service identical to a designated product or a designated service of a first trademark is designated, the first trademark being a subject trademark; a second retrieval unit that retrieves, from an external data source, an actual product that is a product for which a mark with a form identical to that of the second trademark is used or an actual service for which a mark of a form identical to that the second trademark is used; and an associating unit that associates the designated product or the designated service with the actual product or the actual service.

Still another embodiment of the present invention also relates to an information processing apparatus. The apparatus includes: an acknowledgment unit that acknowledges, in determining similarity/dissimilarity between a first mark and a second mark by using a model produced through machine learning based on cases showing similarity/dissimilarity of marks, an input of information indicating a period in which a determination is made; and a determination unit that determines similarity between the first mark and the second mark by factoring in the period in which the determination is made.

Still another embodiment of the present invention relates to an information processing system. The information processing system includes: a storage device that stores, for each particular country, a similarity/dissimilarity determination model produced through machine learning based on cases in the country showing similarity/dissimilarity of marks, the storage device being accessible via a network; an acknowledgment unit that acknowledges an input of a second mark that should be compared with a first mark that is a subject; and a determination unit that acknowledges designation of a target country for which a determination should be made and uses the similarity/dissimilarity determination model of the target country based on designation to retrieve a result of determination on similarity/dissimilarity between the first mark and the second mark.

Still another embodiment of the present invention relates to an information processing method. The method includes: retrieving, using a computer, a second trademark for which a product or a service identical to a designated product or a designated service of a first trademark is designated, the first trademark being a subject trademark; retrieving, using a computer, an actual product that is a product for which a mark with a form identical to that of the second trademark is used or an actual service for which a mark of a form identical to that the second trademark is used, from an external data source; and associating, using a computer, the designated product or the designated service with the actual product or the actual service.

Still another embodiment of the present invention relates to a similarity/dissimilarity determination method. The method includes: acknowledging, using a computer, in determining similarity/dissimilarity between a first mark and a second mark by using a model produced through machine learning based on cases showing similarity/dissimilarity of marks, an input of information indicating a period in which a determination is made; and determining, using a computer, similarity/dissimilarity between the first mark and the second mark by factoring in the period in which the determination is made.

Optional combinations of the aforementioned constituting elements, and implementations of the invention in the form of computer methods, computer programs, recording mediums encoded with computer programs, etc. may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a configuration of an information processing system according to the first embodiment;

FIG. 2 is a block diagram showing the functional blocks of the infringement detection apparatus according to the first embodiment;

FIG. 3 is a flowchart showing the operation of the infringement detection apparatus;

FIG. 4 is also a flowchart showing the operation of the infringement detection apparatus;

FIG. 5 is a block diagram showing the functional blocks of the infringement detection apparatus according to the second embodiment; and

FIG. 6 shows a configuration of an information processing system according to the third embodiment.

### DETAILED DESCRIPTION OF THE INVENTION

The invention will now be described by reference to the preferred embodiments. This does not intend to limit the scope of the present invention, but to exemplify the invention.

This specification proposes a technology of determining similarity/dissimilarity between a subject mark and a collected mark by referring to a model built through machine learning based on various cases showing determination as to whether marks are similar or not (i.e., determination on similarity/dissimilarity). The term “mark” encompasses a plurality of forms, modes, and designs that can be protected as a trademark (including a motion trademark, hologram trademark, trademark consisting only of color, sound trademark, and position trademark). More specifically, a mark means: among those which can be perceived by people, any character, figure, sign or three-dimensional shape or color, or any combination thereof; and sounds. Further, the cases cover one or more types of cases including cases of examination, cases of appeal, and court cases related to trademarks and also including court cases related to Unfair Competition Prevention Act. Further, the cases may cover foreign cases as well as domestic cases. Further, the cases may cover guidelines disclosed by domestic and foreign governments or judicial institutions related to trademarks and acts of unfair competition.

### First Embodiment

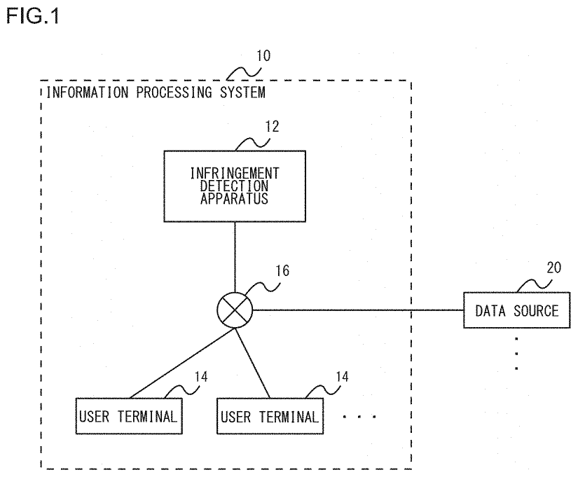

FIG. 1 shows a configuration of an information processing system 10 according to the first embodiment. The information processing system 10 includes a plurality of user terminals 14 and an infringement detection apparatus 12. The plurality of user terminals 14 and the infringement detection apparatus 12 are connected via a communication network 16 exemplified by LAN, WAN, Internet, etc.

The infringement detection apparatus 12 is an information processing apparatus that supports determination on similarity/dissimilarity of marks. In this embodiment, the infringement detection apparatus 12 is an information processing apparatus that provides users with the service of supporting determination on whether a trademark right is infringed. The infringement detection apparatus 12 provides the above-described service implemented as a so-called cloud service to a plurality of user terminals 14 at various locations. Details of the function of the infringement detection apparatus 12 will be described later. The embodiment is non-limiting as to the physical configuration of the infringement detection apparatus 12. For example, the infringement detection apparatus 12 may be implemented by coordinating a plurality of apparatuses such as a web server, an application server, and a database server.

The user terminal 14 is an information processing apparatus operated by a user using the service of the infringement detection apparatus 12. The user terminal 14 may be a PC, a tablet terminal, or a smartphone provided with a web browser. The user may start the web browser on the user terminal 14 and use the service of the infringement detection apparatus 12 via the web browser.

A data source 20 is a generic term for a plurality of information processing apparatuses provided outside the information processing system 10 and capable of providing various information. The data source 20 includes a plurality of web servers providing a plurality of web sites. Further, the data source 20 includes an information provider apparatus that stores and provides data for cases in which a determination on similarity/dissimilarity of marks is made. For example, the data source 20 includes database servers of patent offices and courts of respective countries. Further, the data source 20 includes shopping mall sites, Internet news sites, SNS sites, web pages of enterprise/organization/university/research institute/government, etc., accessible servers storing databases and electronic data.

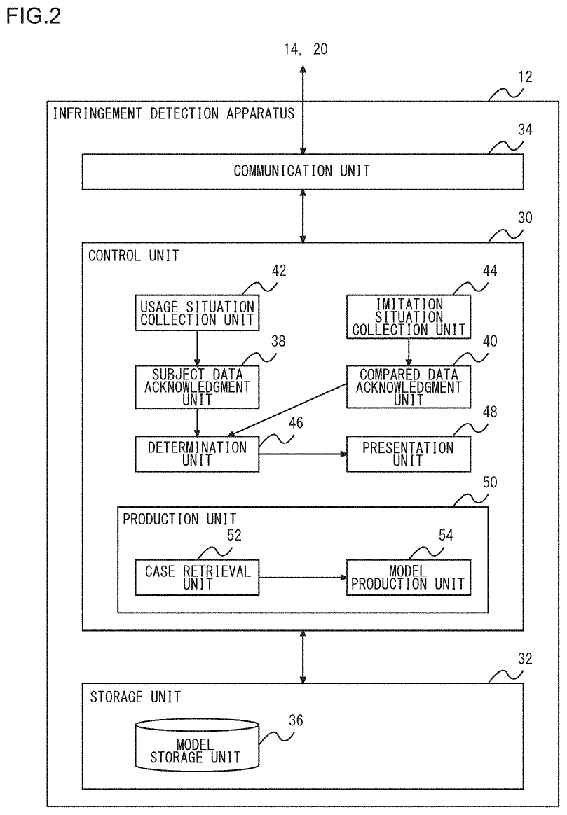

FIG. 2 is a block diagram showing the functional blocks of the infringement detection apparatus 12 according to the first embodiment. The blocks depicted in the block diagram of this specification are implemented in hardware by devices/electronic circuits/mechanical devices exemplified by a processor, a CPU, and a memory of a computer, and in software by a computer program, etc. FIG. 22 depicts functional blocks implemented by the cooperation of these elements. Therefore, it will be understood by those skilled in the art that the functional blocks may be implemented in a variety of manners by a combination of hardware and software.

The infringement detection apparatus 12 includes a control unit 30, a storage unit 32, and a communication unit 34. The control unit 30 performs various data processes related to determination on infringement of marks. The storage unit 32 stores data referred to or updated by the control unit 30. The communication unit 34 communicates with an external apparatus in accordance with a predetermined communication protocol. The control unit 30 transmits and receives various data to and from the user terminal 14 and the data source 20 via the communication unit 34.

The storage unit 32 includes a model storage unit 36. The model storage unit 36 stores a similarity/dissimilarity determination model referred to for determination on similarity/dissimilarity of marks and produced through publicly known machine learning based on a plurality of cases showing similarity/dissimilarity of marks. The similarity/dissimilarity determination model can be said to be a function for which the data format of input and output is predefined. Data related to a mark that is a subject of determination (also called “subject mark”) and data related to a mark that should be compared with the subject mark (also called “compared mark”) are input to the similarity/dissimilarity determination model according to the embodiment. Further, the similarity/dissimilarity determination model according to the embodiment outputs a result of similarity/dissimilarity determination indicating a degree of similarity between the subject mark and the compared mark.

The model storage unit 36 stores a plurality of similarity/dissimilarity determination models corresponding to a plurality of countries and produced based on cases in the plurality of countries. In other words, the similarity/dissimilarity determination model is produced for each of the countries based on cases in the respective countries, and the model storage unit 36 stores the similarity/dissimilarity determination models for the respective countries. The similarity/dissimilarity determination model for a given country is used to determine similarity/dissimilarity of marks in that country. A method of producing the similarity/dissimilarity determination model will be discussed later.

The control unit 30 includes a subject data acknowledgment unit 38, a compared data acknowledgment unit 40, a usage situation collection unit 42, an imitation situation collection unit 44, a determination unit 46, a presentation unit 48, and a production unit 50. An application program in which a plurality of modules corresponding to the plurality of these functional blocks are implemented may be installed in a storage (e.g., the storage unit 32) of the infringement detection apparatus 12. The processor (e.g., a CPU) of the infringement detection apparatus 12 may cause the the respective functional blocks to exhibit their functions by reading the application program into the main memory and executing the application program.

The subject data acknowledgment unit 38 acknowledges an input of data related to a trademark that is a subject of determination (hereinafter, also called “subject trademark”). The data related to a subject trademark includes data for a mark (the subject mark described above) and data showing a product or a service (in the embodiment, data indicating a designated product or a designated service) that the subject mark is used for.

The compared data acknowledgment unit 40 acknowledges an input of data related to a trademark (hereinafter, called “compared trademark”) that should be compared with the subject trademark. The data related to the compared trademark includes data for a mark (the compared mark described above) and data indicating a product or a service that the compared mark is used for.

The usage situation collection unit 42 collects a usage situation of the subject trademark from the data source 20. For example, the usage situation collection unit 42 patrols a plurality of web sites (sales sites, new sites, etc.) on the Internet to collect information on a product or a service that the subject trademark is actually used for and collect the frequency, date/time, etc. of posting of the trademark. The usage situation collection unit 42 delivers the information indicating the usage situation of the subject trademark to the subject data acknowledgment unit 38 and the determination unit 46.

The imitation situation collection unit 44 collects data related to the compared trademark from the data source 20. For example, the imitation situation collection unit 44 may patrol a plurality of web sites on the Internet (sales sites, news sites, etc.) on the Internet to retrieve a compared trademark. Of course, the subject trademark duly used is excluded from the compared trademark. The imitation situation collection unit 44 inputs collected data for the collected compared trademark to the compared data acknowledgment unit 40.

The imitation situation collection unit 44 may retrieve the compared trademark according to the following method from a document (a web page, etc.) provided by the web site. (1) The character or figure posted at a predetermined position (e.g., the top right corner or the bottom right corner) in the document may be retrieved as the compared trademark. (2) In the case a predetermined keyword (which may be a keyword designated by the user) such as a company name is found in the document, the character or figure near the keyword may be retrieved as the compared trademark. (3) In the case a predetermined sign (“TM”, “R”, etc.) indicating a trademark is found in the document, the character or figure near the sign may be retrieved as the compared trademark. (4) In the case tags indicating a trademark is found in a structured document such as an XML document, the data within the tags may be retrieved as the compared trademark.

The imitation situation collection unit 44 may also use a publicly known image analysis technology to extract the compared trademark from moving images uploaded and reproduced on a video-sharing site. For example, the imitation situation collection unit 44 may apply the method (1)-(3) described above for documents to reproduced images and extract the compared trademark from the reproduced images.

The user may designate target where a compared trademark is retrieved. For example, the user may designate a company using the trademark. The user may designate a competitor as a target where the compared trademark is retrieved. The user may designate the compared trademark itself. The compared data acknowledgment unit 40 may acknowledge data for the compared trademark transmitted from the user terminal 14.

The imitation situation collection unit 44 collects the usage situation of the compared trademark from the data source 20. For example, the imitation situation collection unit 44 patrols a plurality of web sites (sales sites, new sites, etc.) on the Internet to collect information on a product or a service that the compared trademark is actually used for and collect the frequency, date/time, etc. of posting of the trademark. The imitation situation collection unit 44 delivers the information indicating the usage situation of the compared trademark to the compared data acknowledgment unit 40 and the determination unit 46.

The determination unit 46 uses the similarity/dissimilarity determination model stored in the model storage unit 36 to determine similarity/dissimilarity between the form of the subject trademark (i.e., the subject mark, which is a mark) and the form of the compared trademark (i.e., the compared mark, which is a mark). More specifically, the determination unit 46 inputs the data for the subject mark acknowledged by the subject data acknowledgment unit 38 and the data for the compared mark acknowledged by the compared data acknowledgment unit 40 to the similarity/dissimilarity determination model. The determination unit 46 acquires a result of similarity/dissimilarity determination including a degree of similarity between the subject mark and the compared mark output from the similarity/dissimilarity determination model.

The determination unit 46 determines whether the subject mark and the compared mark are similar in accordance with the result of similarity/dissimilarity determination output from the similarity/dissimilarity determination model. In the case the degree of similarity indicated by the result of similarity/dissimilarity determination is relatively high, the determination unit 46 determines that the subject mark and the compared mark are similar. In the embodiment, the similarity/dissimilarity determination model outputs a value of 0 to 1 (the larger the value, the higher the degree of similarity) as a degree of similarity. The determination unit 46 may determine that the subject mark and the compared mark are similar when the degree of similarity is equal to or higher than a threshold value (e.g., 0.6). The threshold value may be set to an appropriate value based on the developer's knowledge or a result of experiment using the infringement detection apparatus 12.

When the subject mark and the compared mark are identical or similar and when the designated product or the designated service of the subject trademark is identical or similar to the product or the service that the compared trademark is used for, the determination unit 46 determines that the compared trademark is in conflict with the subject trademark. In the case the subject trademark is a registered trademark, the determination unit 46 determines that the compared trademark infringes the trademark right of the subject trademark. When the subject mark and the compared mark are not similar (the degree of similarity is less than a threshold value) or when the designated product or the designated service of the subject trademark does not cover the product or the service that the compared trademark is used for, the determination unit 46 determines that the compared trademark is not in conflict with the subject trademark. The determination unit 46 delivers the result of determination to the presentation unit 48.

The determination unit 46 acknowledges data transmitted from the user terminal 14 and showing a country (target country) designated by the user for which a determination should be made. Of the similarity/dissimilarity determination models for the respective countries stored in the model storage unit 36, the determination unit 46 uses the similarity/dissimilarity determination model of the target country to determine similarity/dissimilarity between the subject mark and the compared mark, i.e., determine whether the compared trademark is in conflict with the subject trademark.

The presentation unit 48 transmits user support information including the result of determination by the determination unit 46 to the user terminal 14 and causes the information to be displayed, thereby presenting the result of determination by the determination unit 46 to the user. The user support information includes the following items. (1) The result of determination by the determination unit 46, i.e., information indicating whether the compared trademark is in conflict with the subject trademark, i.e., whether the compared trademark infringes the trademark right of the subject trademark. (2) Reason for determination on the presence or absence of conflict. In this embodiment, information indicating the degree of similarity between the subject trademark and the compared trademark or information indicating that a predetermined feature referred to for determination on the degree of similarity lacks. (3) Information related to the usage situation of the subject trademark collected by the usage situation collection unit 42. (4) Information related to the usage situation of the compared trademark collected by the imitation situation collection unit 44.

In the case that there are a plurality of subject trademarks and/or a plurality of compared trademarks, the determination unit 46 makes a determination on the presence or absence of conflict for each combination of one subject trademark and one compared trademark. The presentation unit 48 transmits user support information including the result of determination by the determination unit 46 to the user terminal 14 and causes the information to be displayed for each combination of one subject trademark and one compared trademark.

The production unit 50 produces a similarity/dissimilarity determination model based on a plurality of cases showing similarity/dissimilarity of marks and stores the produced similarity/dissimilarity determination model in the model storage unit 36. Further, the production unit 50 updates the similarity/dissimilarity determination model stored in the model storage unit 36 based on new cases showing similarity/dissimilarity of marks. In other words, the production unit 50 also functions as an updating unit for producing a new similarity/dissimilarity determination model different from the existent similarity/dissimilarity determination model.

The production unit 50 includes a case retrieval unit 52 and a model production unit 54. The case retrieval unit 52 acquires, from the data source 20, data showing similarity/dissimilarity of marks in a plurality of countries such as Japan, United States, and Germany and related to a plurality of cases such as those in the examination, appeal, and court. The data source 20 may be comprised of a plurality of databases storing cases of a plurality of countries. The data for each case includes data (data indicating appearance, sound, concept, etc.) for the first mark and the second mark subject to comparison and includes a result of determination as to whether the marks are similar.

The model production unit 54 uses the data related to a plurality of cases retrieved by the case retrieval unit 52 as a plurality of items of supervising data so as to produce a plurality of similarity/dissimilarity determination models corresponding to the plurality of countries. For example, the model production unit 54 produces a similarity/dissimilarity determination model for Japan, a similarity/dissimilarity determination model for the United States, a similarity/dissimilarity determination model for Germany, . . . . The model production unit 54 according to the embodiment produces a similarity/dissimilarity determination model through machine learning (supervised learning) by using the data for the first mark and the second mark and the result of similarity/dissimilarity determination as supervising data. The model production unit 54 may produce the similarity/dissimilarity determination model by using a publicly known machine learning method such as support vector machine, neural network (including deep learning), and random forest.

The result of similarity/dissimilarity determination in the supervising data may be set to “1” in the case of identical or similar marks and to “0” in the case of dissimilar marks. The result of similarity/dissimilarity determination in the supervising data may be set to “1” in the case of identical marks, to “0.7” in the case of similar marks, and to “0” in the case of dissimilar marks. In other words, when the marks are determined to be similar, the result may be set to a value smaller than that of the case where the marks are determined to be identical and larger than that of the case where the marks are determined to be dissimilar. In this case, the similarity/dissimilarity determination model outputs the degree of similarity between the subject mark and the compared mark in a range of 0-1 (the closer to 1, the higher the similarity).

The case retrieval unit 52 periodically retrieves case data of a plurality of countries (in this case, new case data) from a plurality of data sources 20. The model production unit 54 periodically updates the plurality of similarity/dissimilarity determination models corresponding to the plurality of countries based on the new case data retrieved by the case retrieval unit 52.

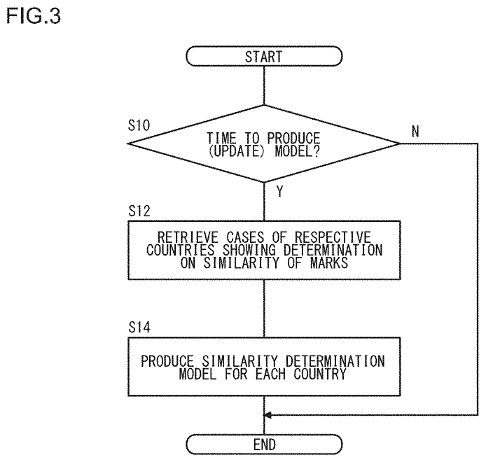

A description will now be given of the operation of the information processing system 10 with the above configuration. FIG. 3 is a flowchart showing the operation of the infringement detection apparatus 12. The figure depicts the operation related to the production of the similarity/dissimilarity determination model. When the predefined scheduled time to produce the model or the predefined schedule time to update the model arrives (Y in S10), the case retrieval unit 52 of the infringement detection apparatus 12 retrieves cases of respective countries showing determination on similarity/dissimilarity of marks from the data source 20 (S12). The model production unit 54 produces similarity/dissimilarity determination models for respective countries through machine learning based on the cases in the respective countries and stores the models in the model storage unit 36 (S14).

When the scheduled time to produce the model or the schedule time to update the model has not arrived (N in S10), S12 and S14 are skipped. The scheduled time to produce the model or the schedule time to update the model may be when the manager of the infringement detection apparatus 12 inputs an instruction to update the model. The scheduled time to update the model may be when an elapse of a predetermined period of time (e.g., three months) since the production of the previous similarity/dissimilarity determination model. The infringement detection apparatus 12 may perform the steps shown in FIG. 3 repeatedly.

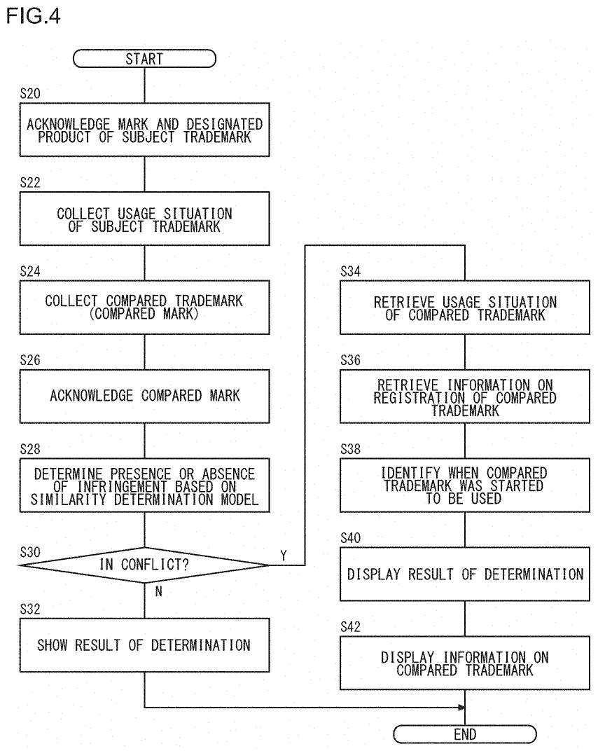

FIG. 4 is also a flowchart showing the operation of the infringement detection apparatus 12. The figure shows the operation related to infringement detection. The user enters information related to the subject trademark by inputting the mark of the subject trademark (subject mark) and information indicating the designated product or the designated service to the user terminal 14. The user terminal 14 transmits an infringement determination instruction including the information related to the subject trademark to the infringement detection apparatus 12. The subject data acknowledgment unit 38 of the infringement detection apparatus 12 acknowledges an input of the information related to the subject trademark transmitted from the user terminal 14 (S20). It is assumed here that the subject trademark is a registered trademark owned by the enterprise that the user belongs to (i.e., the trademark of authentic products).

The usage situation collection unit 42 collects the usage situation of the subject trademark from the data source 20 (S22). For example, the usage situation collection unit 42 collects data indicating whether the subject trademark is used in conjunction with the company that the user belongs to or the product sold by the company, and data indicating how the subject trademark is used in web sites (company sites, external sales site, news sites, etc.).

The imitation situation collection unit 44 collects information on the compared trademark from the data source 20 (S24). For example, the imitation situation collection unit 44 may collect, as the compared trademark, one or more trademarks posted on a plurality of web sites (which may be web sites of the enterprise or the domain designated by the user) and different from the subject trademark. The compared data acknowledgment unit 40 acknowledges an input of the compared trademark collected by the imitation situation collection unit 44 (S26). As in the case of the subject trademark, the compared trademark may be designated by the user. In other words, the compared trademark may be input from the user terminal 14.

The information processing system 10 may be provided with a drone (i.e., unmanned aircraft) carrying a camera. The drone may capture images of the real world to collect information on the trademark used in the actual world. The imitation situation collection unit 44 may extract the compared trademark by extracting a trademark shown in the image captured by the drone.

The subsequent steps are performed for each combination of one subject trademark and one compared trademark. The determination unit 46 inputs the mark of the subject trademark (i.e., the subject mark) input in S20 and the mark of the compared trademark (i.e., the compared mark) input in S26 to the similarity/dissimilarity determination model stored in the model storage unit 36 and retrieves a result of similarity/dissimilarity determination output from the similarity/dissimilarity determination model. When the degree of similarity between the subject mark and the compared mark indicated by the result of similarity/dissimilarity determination is equal to higher than a threshold value and when the designated product of the subject trademark covers the mode of usage of the compared trademark, the determination unit 46 determines that the compared trademark is in conflict with the subject trademark (S28).

In S28, the determination unit 46 uses the similarity/dissimilarity determination model for the target country designated by the user and communicated from the user terminal 14. When a plurality of target countries are designated, the determination unit 46 uses the similarity/dissimilarity determination models for the respective countries to obtain results of similarity/dissimilarity determination for the respective countries. In the case that there are a plurality of subject trademarks and/or a plurality of compared trademarks, the determination unit 46 makes a determination on conflict for each combination of one subject trademark and one compared trademark.

In the case the result of determination by the determination unit 46 indicates that the compared trademark is not in conflict with the subject trademark (N in S30), the presentation unit 48 transmits the result of determination by the determination unit 46 showing the presence or absence of conflict to the user terminal 14 and causes the result to be displayed (S32). The result of determination may include the mark of the subject trademark, the mark of the compared trademark, the result of similarity/dissimilarity determination (in this case, dissimilar), and the reason for the determination (in this case, the degree of similarity equal to or lower than the threshold value).

In the case the result of determination by the determination unit 46 indicates that the compared trademark is in conflict with the subject trademark (Y in S30), the imitation situation collection unit 44 collects information indicating the usage situation of the compared trademark for which a determination of conflict is made (hereinafter, also called “trademark in conflict”) from the data source 20 (S34). The imitation situation collection unit 44 may retrieve information on the product or the service for which the trademark in conflict is used or information on the location of use (URL, etc.) based on what is posted on a plurality of web pages. Further, the imitation situation collection unit 44 may retrieve, from a WHOIS server, etc., information on the server location and the manager based on the Internet address of the server providing the web page.

As already described, the the information processing system 10 may be provided with a drone carrying a camera. The drone may capture images of the real world to collect information on the trademark in conflict used in the actual world. The imitation situation collection unit 44 may acquire a plurality of captured images and information on the position that each image is captured (positioning information obtained by GPS, etc.) from the drone. The determination unit 46 may refer to position information input from the drone and map information to identify the address, the shop, etc. in which each image is captured.

Further, the imitation situation collection unit 44 searches the data source 20 (e.g., databases of patent offices of respective countries) to check whether the trademark in conflict is registered in a public institution, i.e., whether the trademark in conflict is a registered trademark. In the case the trademark in conflict is a registered trademark, the imitation situation collection unit 44 retrieves information related to the registration of the trademark in conflict (application date, registration date, designated product, designated service, etc.) from the data source 20 (S36).

The determination unit 46 estimates when the trademark in conflict was started to be used, based on the information related to the trademark in conflict collected by the imitation situation collection unit 44 (S38). The determination unit 46 may extract the date and time when the web page including the trademark in conflict was posted or registered in the web site from the data for the web page and use the date and time of posting or the date and time of registration to estimate when the trademark in conflict was started to be used.

Alternatively, the determination unit 46 may refer to deterioration of the shop, signboard, etc. shown in the image captured by the drone, etc. to estimate when the trademark in conflict shown in the image was started to be used. For example, the determination unit 46 may store correspondence between the degree of deterioration of the shop, signboard, etc. and the period of time that caused the deterioration and estimate the time going back the period of time corresponding to degree of deterioration of the shop, signboard, etc. shown in the captured image from the current point of time as the time when trademark in conflict was started to be used.

The presentation unit 48 transmits the result of determination by the determination unit 46 showing the presence or absence of conflict to the user terminal 14 and causes the result to be displayed (S40). On top of that, the presentation unit 48 transmits additional information by transmitting, to the user terminal 14, the information indicating the usage situation of the subject trademark retrieved in S22, the information indicating the usage situation of the trademark in conflict retrieved in S34, the information on the registration of the trademark in conflict retrieved in S36, and the time when the trademark in conflict was started to be used estimated in S38 and causes the information to be displayed (S42).

Thus, in the case there is a conflict between the subject trademark and the compared trademark, the user is assisted when considering the action to take by providing many items of additional information to the user. By collecting additional information when there is a conflict between the subject trademark and the compared trademark, an increase in the volume of data processing in the infringement detection apparatus 12 is inhibited. The step shown in S22 of retrieving the usage situation of the subject trademark may be performed only when there is a conflict between the subject trademark and the compared trademark.

According to the infringement detection apparatus 12 of the first embodiment, the precision of determination on similarity/dissimilarity of marks in various modes (figure, sounds, etc. as well as characters) is increased by determining similarity/dissimilarity of marks by using the model produced through machine learning based on various cases showing similarity/dissimilarity of marks. For example, cases of a high likelihood of conflict or infringement are inhibited from escaping the search. Also, cases of low likelihood of conflict or infringement are inhibited from being identified as showing conflict or infringement.

In further accordance with the infringement detection apparatus 12, the use of similarity/dissimilarity determination models for respective countries for determination on similarity/dissimilarity of marks allows the intellectual property systems and the tendencies in similarity/dissimilarity determination of the respective countries to be reflected and increases the precision of similarity/dissimilar determination for each country. In still further accordance with the infringement detection apparatus 12, the user can be presented with information referred to by the user when considering an action to take, by presenting the degree of similarity between the subject mark and the compared mark as a reason for determination by the infringement detection apparatus 12.

In still further accordance with the infringement detection apparatus 12, similarity/dissimilarity of marks can be determined based on the latest guideline and tendency, by updating the similarity/dissimilarity determination model based on new cases. In still further accordance with the infringement detection apparatus 12, it is possible to retrieve information on the compared trademark and the trademark in conflict that are used in the real world as well as those used in the virtual world, including the Internet, thereby increasing the completeness of conflict/infringement determination.

In the embodiment described above, the data for the subject trademark is assumed to be input to the infringement detection apparatus 12 from the user terminal 14. In one variation, the data may be stored in advance in the storage unit 32 of the infringement detection apparatus 12. In the case the infringement detection apparatus 12 detects a trademark of another company in conflict with the user's trademark, the data related to the user's trademark (including the subject mark) may be stored in advance in the storage unit 32. In the case the determination unit 46 of the infringement detection apparatus 12 is implemented by a computer program, the data for the subject trademark may be statically defined in the computer program.

The determination unit 46 may use a plurality of similarity/dissimilarity determination models corresponding to a plurality of countries and determine, for each country, whether the compared trademark is in conflict with the subject trademark, although the feature is not referred to in the embodiment described above. The presentation unit 48 may display a list of results of conflict determination for the respective countries in the user terminal 14. Further, when it is found that the compared trademark is used one or more countries (called “country of use”) based on the usage situation of the compared trademark retrieved by the imitation situation collection unit 44, the determination unit 46 may determine whether the compared trademark is in conflict with the subject trademark for each country of use, by using the similarity/dissimilarity determination models of the respective countries of use. The presentation unit 48 may cause the user terminal 14 to display a list of results of conflict determination for the respective countries of use.

Separate similarity/dissimilarity determination models may be used for the respective countries, but only one similarity/dissimilarity determination model may be defined. In the latter case, the determination unit 46 may determine whether there is a conflict in the target country by inputting an identification code for the target country designated by the user to the similarity/dissimilarity determination model as a parameter.

In the case separate similarity/dissimilarity determination models are provided for respective countries, each similarity/dissimilarity determination model may be produced based only on cases (examination cases, appeal cases, court cases, etc.) in a particular country. According to this mode, conflict determination suited to the determination in a particular country can be realized.

The similarity/dissimilarity determination model according to the embodiment described above is assumed to output the degree of similarity between the subject mark and the compared mark. In one variation, the similarity/dissimilarity determination model may output data indicating a conclusion of whether the subject mark and the compared mark are similar or not, in place of or in addition to the degree of similarity between the subject mark and the compared mark. The determination unit 46 may determine whether the subject mark and the compared mark are similar in accordance with the data indicating the conclusion.

The determination unit 46 and the presentation unit 48 according to the embodiment described above present the degree of similarity between the subject mark and the compared mark to the user as a reason for determination. In one variation, another reason for determination may be presented to the user. The other reason for determination may be a description of why the similarity/dissimilarity determination model has concluded that the subject mark and the compared mark are similar (or dissimilar), i.e., a description of the logic leading to the conclusion of similarity/dissimilarity determination.

The other reason for determination may be produced by a publicly known method. For example, as described in “https://forbesjapancom/articles/detail/21330”, the determination unit 46 may extract “lacking information”, which has caused the similarity/dissimilarity determination model to conclude that the subject mark and the compared mark are similar (or dissimilar), as a reason for determination, and the presentation unit 48 may present the “lack of information” to the user as the reason for determination.

The model production unit 54 may produce the similarity/dissimilarity determination model through machine learning that prioritizes cases showing judgment in higher courts over cases showing judgment in lower courts, although the feature is not referred to in the embodiment described above. Further, the model production unit 54 may produce the similarity/dissimilarity determination model through machine learning that prioritizes cases showing new judgment over cases showing old judgment. For example, the model production unit 54 may produce the similarity/dissimilarity determination model by weighing the supervising data in the order examination cases<appeal cases<local court cases<high court cases<supreme court cases.

Further, the model production unit 54 may produce the similarity/dissimilarity determination model by weighing supervising data based on new cases more heavily than the other data.

In the embodiment described above, it is assumed that the similarity/dissimilarity determination model is produced by supervised learning. Alternatively, the similarity/dissimilarity determination model may be produced without supervised learning. The model production unit 54 may use a publicly known cluster analysis to produce the similarity/dissimilarity determination model such that the pair of the first mark and the second mark compared in a case is categorized in one of the first group and the second group. Subsequently, a method not relying on machine learning (e.g., manual categorization) may be used to check which of the first group and the second group is a group of similarity and which is a group dissimilarity. In the case the first group is a group of similarity and the second group is a group of dissimilarity, the determination unit 46 may input the pair of the subject mark and the compared mark to the similarity/dissimilarity determination model to retrieve whether the pair is categorized in the first group or the second group from the similarity/dissimilarity determination model. The determination unit 46 may determine that the subject mark and the compared mark are similar when the pair of the subject mark and the compared mark is categorized in the first group and determine that the subject mark and the compared mark are dissimilar when the pair is categorized in the second group.

### Second Embodiment

In the second embodiment, the presence or absence of conflict/infringement is determined by factoring in the range of actual products and/or services covered by the designated product and/or designated service of the subject trademark. Hereinafter, the designated product and/or designated service will also be referred to by a generic term “designated product etc.”.

Those elements constituting the information processing system of the second embodiment that are identical to or corresponding to the elements of the first embodiment shall be denoted by the same reference numerals as the first embodiment. A description of the details already explained in the first embodiment will not be duplicated, and difference from the first embodiment will be mainly highlighted.

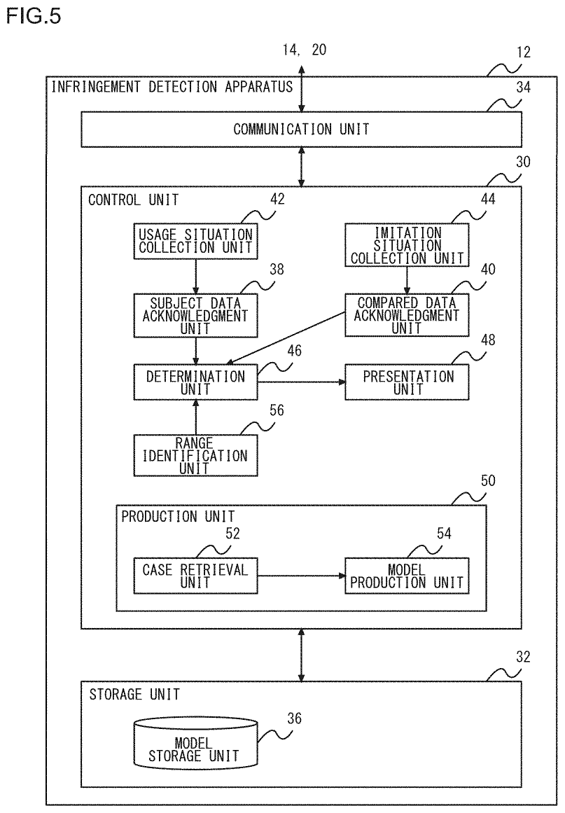

The configuration of the information processing system according to the second embodiment is similar to that of the first embodiment (FIG. 1). FIG. 5 is a block diagram showing the functional blocks of the infringement detection apparatus 12 according to the second embodiment. In addition to the functional blocks of the first embodiment, the infringement detection apparatus 12 according to the second embodiment is provided with a range identification unit 56.

The subject data acknowledgment unit 38 acknowledges the designated product etc. of the subject trademark (e.g., the user's registered trademark) input from the user terminal 14. The range identification unit 56 retrieves, from the data source 20, data for a trademark (hereinafter, called “reference trademark”) different from the subject trademark and registered in a public institution by designating the designated product etc. of the subject trademark. The data for the reference trademark includes at least the mark of the reference trademark. The data source 20 may be a patent office database or a private sector trademark database in a country in which the presence or absence of infringement should be determined.

The range identification unit 56 retrieves data related to the product (also called “actual product”) or the service (also called “actual service”) for which the mark of the reference trademark is actually used from the data source 20. For example, the range identification unit 56 retrieves the name of the actual product or the name of the actual service. For example, the range identification unit 56 retrieves information on the actual product etc. for which the mark of the reference trademark is used from a web page of the enterprise owing the trademark right of the reference trademark. In this process, the range identification unit 56 also retrieves, from the catalog of the product etc., the generic term of the product etc., the range of demanders of the product etc., and the usage and function of the product etc., as much as possible. The range identification unit 56 identifies the range of the product etc. based on the retrieved information. These items of information may be collected from a shopping mall site instead of the web page of the enterprise. Still alternatively, the data source 20 may be searched based on an image or a description of the product etc. carried in the catalog of the product etc. to retrieve the generic term of the product etc., the range of demanders of the product etc., and information related to the usage and function of the product etc. Like the imitation situation collection unit 44 of the first embodiment, the range identification unit 56 may also retrieve the usage situation of the reference trademark in a plurality of web sites on the Internet. Further, the range identification unit 56 may retrieve the usage situation of the reference trademark in the real world based on an image captured by a drone etc. For example, the captured image may be analyzed by image processing to retrieve information related to demanders using the product etc. (sex, adult/child, how they are reached by advertisement, etc.) and information related to the usage and function of the product etc. (when, where, and how the product etc. is consumed, etc.).

The range identification unit 56 associates the designated product or the designated service of the subject trademark with the product and the service for which the reference trademark is actually used (i.e., the actual product and the actual service). In the second embodiment, the range identification unit 56 outputs the actual product and the actual service as being covered by the designated product etc. of the subject trademark. In the second embodiment, the range identification unit 56 inputs information indicating the product and the service for which the reference trademark is actually used to the determination unit 46. The determination unit 46 defines a set of i) the product and the service input from the user terminal 14 for which the subject trademark is actually used and ii) the product and the service input from the range identification unit 56 for which the reference trademark is actually used, as a range of the designated product etc. of the subject trademark (products or services included in a scope identical or similar to the designated product or service). The determination unit 46 determines the presence or absence of conflict between the subject trademark and the compared trademark accordingly. In other words, when it is determined that the mark of the subject trademark and the mark of the compared trademark are similar according to the similarity determination model, and, when the product or the service for which the compared trademark is used is included in the set defined above, i.e., is identical to or similar to the designated product or service, the determination unit 46 determines that the compared trademark is in conflict with the subject trademark.

In addition to the detail presented in the first embodiment, the presentation unit 48 may cause the user terminal 14 to display the information on the product and/or service identified by the range identification unit 56 as being covered by the designated product etc. of the subject trademark. In accordance with the infringement detection apparatus 12 of the second embodiment, the presence or absence of conflict between the subject trademark and the compared trademark can be determined by factoring in the range of actual products/services covered by the designated product and the designated service of the subject trademark designated by the user. Moreover, the user is assisted to know the range of actual products/services covered by the designated product and the designated service of the subject trademark.

In one variation, the technology described in the second embodiment may be applied for implementation in an information processing apparatus such that a determination on conflict of trademarks is not made, and the information on products, etc. identified by the range identification unit 56 as being covered by the designated product and the designated service of the subject trademark is displayed in the user terminal 14.

### Third Embodiment

In the third embodiment, a plurality of similarity/dissimilarity determination models corresponding to a plurality of countries are distributed in a plurality of countries and managed accordingly. Those elements constituting the information processing system of the third embodiment that are identical to or corresponding to the elements of the first embodiment shall be denoted by the same reference numerals as the first embodiment. A description of the details already explained in the first embodiment will not be duplicated, and difference from the first embodiment will be mainly highlighted.

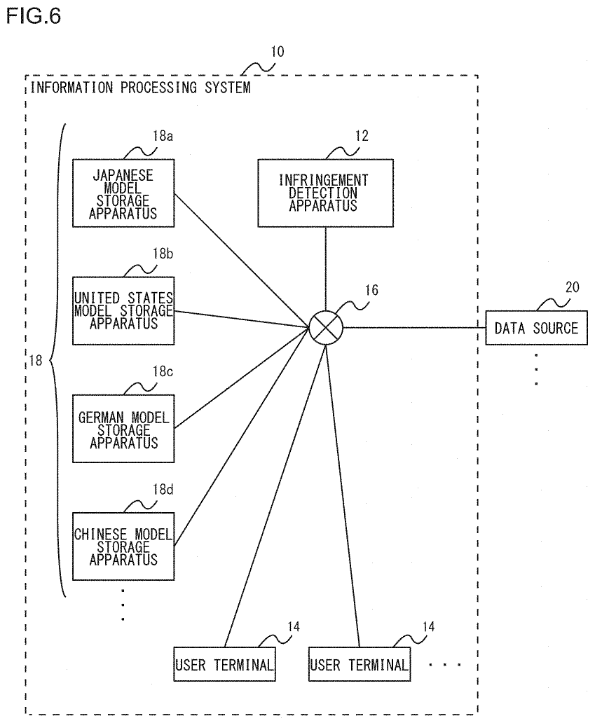

FIG. 6 shows a configuration of an information processing system 10 according to the third embodiment. In addition to the elements of the first embodiment, the information processing system 10 according to the third embodiment is provided with a plurality of model storage apparatuses 18 including a Japanese model storage apparatus 18a, a United States model storage apparatus 18b, a German model storage apparatus 18c, and a Chinese model storage apparatus 18d. The infringement detection apparatus 12 is configured to be capable of accessing the plurality of model storage apparatuses 18 via the communication network 16 including the Internet.

The plurality of model storage apparatuses 18 are storage apparatuses (e.g., information processing apparatuses provided with storage units) corresponding to a plurality of countries. The Japanese model storage apparatus 18a stores a similarity/dissimilarity determination model for Japan produced through machine learning based on Japanese cases, and the United States model storage apparatus 18b stores a similarity/dissimilarity determination model for the United States produced through machine learning based on U.S. cases. The German model storage apparatus 18c stores a similarity/dissimilarity determination model for Germany produced through machine learning based on German cases, and the Chinese model storage apparatus 18d stores a similarity/dissimilarity determination model for China produced through machine learning based on Chinese cases.

The embodiment is non-limiting as to the location where the plurality of model storage apparatuses 18 are installed. The devices may be placed in one location or distributed in different places in the world. For example, the Japanese model storage apparatus 18a may be placed in Japan, and the similarity/dissimilarity determination model for Japan may be produced, updated, and maintained by patent firms in Japan. Similarly, the United States model storage apparatus 18b, the German model storage apparatus 18c, and the Chinese model storage apparatus 18d may be placed in the U.S., Germany, and China, respectively, and the similarity/dissimilarity determination models of the respective countries may be produced, updated, and maintained by patent firms in the respective countries.

The determination unit 46 of the infringement detection apparatus 12 acknowledges data showing the target country designated by the user from the user terminal 14. Of the plurality of model storage apparatuses 18, the determination unit 46 accesses the model storage apparatus 18 corresponding to the target country and uses the similarity/dissimilarity determination model stored in the accessed model storage apparatus 18 to retrieve a result of determination on similarity/dissimilarity between the subject mark and the compared mark.

For example, the determination unit 46 may transmit the data for the subject mark and the data for the compared mark to the model storage apparatus 18 corresponding to the target country and retrieve the result of determination by the similarity/dissimilarity determination model from that model storage apparatus 18. Alternatively, the determination unit 46 may download the similarity/dissimilarity determination model from the model storage apparatus 18 corresponding to the target country, inputs the data for the subject mark and the data for the compared mark to the similarity/dissimilarity determination model, and retrieve the result of determination by the similarity/dissimilarity determination model. The subsequent steps performed in the infringement detection apparatus 12 are similar to those of the first embodiment.

In accordance with the information processing system 10, the use of similarity/dissimilarity determination models for respective countries for determination on similarity/dissimilarity of marks can factor in the intellectual property systems and the tendencies in similarity/dissimilarity determination of the respective countries and increase the precision of similarity/dissimilarity determination for each country. Moreover, since the similarity/dissimilarity determination models for the respective countries are distributed and managed in the respective countries, the models can be produced, updated, and maintained by experts of the respective countries.

### Fourth Embodiment

In the fourth embodiment, similarity/dissimilarity of marks is determined by factoring in a period of time designated by the user. Those elements constituting the infringement detection apparatus 12 of the fourth embodiment that are identical to or corresponding to the elements of the first embodiment shall be denoted by the same reference numerals as the first embodiment. A description of the details already explained in the first embodiment will not be duplicated, and difference from the first embodiment will be mainly highlighted.

The model storage unit 36 of the infringement detection apparatus 12 stores a plurality of similarity/dissimilarity determination models corresponding to a plurality of similarity/dissimilarity determination periods that can be selected by the user. For example, the model storage unit 36 may store similarity/dissimilarity determination models for respective periods each spanning three years such as a similarity/dissimilarity determination model corresponding to 2009-2011, a similarity/dissimilarity determination model corresponding to 2012-2014, a similarity/dissimilarity determination model corresponding to 2015-2017, etc. The model storage unit 36 may store a plurality of similarity/dissimilarity determination models for each combination of a country and a similarity/dissimilarity determination period.

In the case of producing a similarity/dissimilarity determination model corresponding to a particular similarity/dissimilarity determination period (e.g., a period of three years as described above), the case retrieval unit 52 collect cases (examination, appeal, court, etc.) showing determination on similarity/dissimilarity of marks made during the particular similarity/dissimilarity determination period from the data source 20. The model production unit 54 produces a similarity/dissimilarity determination model corresponding to the particular similarity/dissimilarity determination period based on the cases collected by the case retrieval unit 52 and stores the produced model in the model storage unit 36. The similarity/dissimilarity determination period may be set to have an appropriate duration based on the developer's knowledge or a result of experiment using the infringement detection apparatus 12.

The subject data acknowledgment unit 38 acknowledges the data related to the subject trademark from the user terminal 14 and acknowledges the data showing the similarity/dissimilarity determination period designated by the user from the user terminal 14.

The determination unit 46 factors in the similarity/dissimilarity determination period designated by the user to determine similarity/dissimilarity between the subject mark and the compared mark. More specifically, of the plurality of similarity/dissimilarity determination models stored in the model storage unit 36, the determination unit 46 uses the similarity/dissimilarity determination model corresponding to the similarity/dissimilarity determination period designated by the user to determine similarity/dissimilarity between the subject mark and the compared mark.

The tendency in determination on similarity/dissimilarity of marks may vary depending on the period in which the determination is made. Also, infringement in the past matters in a damage claim, and so it is useful to determine similarity/dissimilarity of marks by factoring in the period. According to the infringement detection apparatus 12 of the fourth embodiment, the result of determination on similarity/dissimilarity of marks in the period designated by the user can be provided to the user so that the user studying trademark right infringement etc. can be more effectively assisted.

In one variation, the model production unit 54 may include, in the supervising data, information indicating the period in which a determination on similarity/dissimilarity of marks is made in each case, when producing a similarity/dissimilarity determination model. In other words, the model production unit 54 may produce a similarity/dissimilarity determination model that factors in the period in which a determination on similarity/dissimilarity of marks is made. The similarity/dissimilarity determination period may be a period in which the examination, appeal, or court decision was made. More specifically, the similarity/dissimilarity determination period may be a period in which a conclusion was drawn in each case. The determination unit 46 may retrieve the similarity/dissimilarity determination result factoring in the similarity/dissimilarity determination period from the similarity/dissimilarity determination model, by inputting the similarity/dissimilarity determination period to the similarity/dissimilarity determination model in addition to the data for the subject mark and the data for the compared mark.

Described above is an explanation of the present invention based on the first through embodiments. The embodiments are intended to be illustrative only and it will be obvious to those skilled in the art that various modifications to combinations of constituting elements and processes described in the embodiments could be developed other than the variations already described and that such modifications are also within the scope of the present invention.

Any combination of the embodiment and the variation described above will also be useful as an embodiment of the present invention. A new embodiment created by a combination will provide the combined advantages of the embodiment and the variation as combined. It will be understood to a skilled person that the functions that the constituting elements recited in the claims should achieve are implemented either alone or in combination by the constituting elements shown in the embodiments and the variations.

What is claimed is:

1. An information processing apparatus comprising:
a storage unit that stores a similarity/dissimilarity determination model produced through machine learning based on a plurality of cases showing determination on similarity/dissimilarity of marks;
an acknowledgment unit that acknowledges an input of a second mark that should be compared with a first mark that is a subject of determination; and
a determination unit that determines similarity/dissimilarity between the first mark and the second mark by using the similarity/dissimilarity determination model stored in the storage unit.

2. The information processing apparatus according to claim 1, wherein
the plurality of cases include cases of a plurality of countries, and the similarity/dissimilarity determination model is produced for each of the plurality of countries, and
the determination unit acknowledges designation of a target country for which a determination should be made and uses the similarity/dissimilarity determination model for the target country based on designation.

3. The information processing apparatus according to claim 1, wherein
the similarity/dissimilarity determination model is produced based only on cases in a particular country.

4. The information processing apparatus according to claim 1, wherein
a determination on similarity/dissimilarity in the determination unit includes determining a degree of similarity in addition to determining whether the first mark and the second mark are similar or dissimilar,
the information processing apparatus further comprising a presentation unit that presents the degree of similarity.

5. The information processing apparatus according to claim 1, further comprising:
an updating unit that updates the similarity/dissimilarity determination model stored in the storage unit based on a new case showing similarity/dissimilarity of marks.

6. The information processing apparatus according to claim 1, further comprising:
a collection unit that collects the second mark by patrolling a plurality of web sites.

7. An information processing apparatus comprising:
a first retrieval unit that retrieves a second trademark for which a product or a service identical to a designated product or a designated service of a first trademark is designated, the first trademark being a subject trademark;
a second retrieval unit that retrieves, from an external data source, an actual product that is a product for which a mark with a form identical to that of the second trademark is used or an actual service for which a mark of a form identical to that the second trademark is used; and
an associating unit that associates the designated product or the designated service with the actual product or the actual service.

8. An information processing apparatus comprising:
an acknowledgment unit that acknowledges, in determining similarity/dissimilarity between a first mark and a second mark by using a model produced through machine learning based on cases showing similarity/dissimilarity of marks, an input of information indicating a period in which a determination is made; and
a determination unit that determines similarity between the first mark and the second mark by factoring in the period in which the determination is made.

9. An information processing system comprising:
a storage device that stores, for each particular country, a similarity/dissimilarity determination model produced through machine learning based on cases in the country showing similarity/dissimilarity of marks, the storage device being accessible via a network;
an acknowledgment unit that acknowledges an input of a second mark that should be compared with a first mark that is a subject; and
a determination unit that acknowledges designation of a target country for which a determination should be made and uses the similarity/dissimilarity determination model of the target country based on designation to retrieve a result of determination on similarity/dissimilarity between the first mark and the second mark.

10. An information processing method comprising:
retrieving, using a computer, a second trademark for which a product or a service identical to a designated product or a designated service of a first trademark is designated, the first trademark being a subject trademark;
retrieving, using a computer, an actual product that is a product for which a mark with a form identical to that of the second trademark is used or an actual service for which a mark of a form identical to that the second trademark is used, from an external data source; and
associating, using a computer, the designated product or the designated service with the actual product or the actual service.

11. A similarity/dissimilarity determination method comprising:
acknowledging, using a computer, in determining similarity/dissimilarity between a first mark and a second mark by using a model produced through machine learning based on cases showing similarity/dissimilarity of marks, an input of information indicating a period in which a determination is made; and
determining, using a computer, similarity/dissimilarity between the first mark and the second mark by factoring in the period in which the determination is made.

12. A computer readable recording medium storing a computer program,
the computer program comprising computer-implemented modules including:
a module that stores a similarity/dissimilarity determination model produced through machine learning based on a plurality of cases showing determination on similarity/dissimilarity of marks;
a module that acknowledges an input of a second mark that should be compared with a first mark that is a subject of determination; and
a module that determines similarity/dissimilarity between the first mark and the second mark by using the similarity/dissimilarity determination model stored.

13. A computer readable recording medium storing a computer program, the computer program comprising computer-implemented modules including:
a module that retrieves a second trademark for which a product or a service identical to a designated product or a designated service of a first trademark is designated, the first trademark being a subject trademark,
a module that retrieves, from an external data source, an actual product that is a product for which a mark with a form identical to that of the second trademark is used or an actual service for which a mark of a form identical to that the second trademark is used; and
a module that associates the designated product or the designated service with the actual product or the actual service.

14. A computer readable recording medium storing a computer program, the computer program comprising computer-implemented modules including:
a module that acknowledges, in determining similarity/dissimilarity between a first mark and a second mark by using a model produced through machine learning based on cases showing similarity/dissimilarity of marks, an input of information indicating a period in which a determination is made; and
a module that determines similarity/dissimilarity between the first mark and the second mark by factoring in the period in which the determination is made.

15. A computer readable recording medium storing a computer program, the computer program comprising modules implemented in an information processing system including a storage device that stores, for each particular country, a similarity/dissimilarity determination model produced through machine learning based on cases in the country showing similarity/dissimilarity of marks, the storage device being accessible via a network, the modules including:
a module that acknowledges an input of a second mark that should be compared with a first mark that is a subject; and
a module that acknowledges designation of a target country for which a determination should be made and uses the similarity/dissimilarity determination model of the target country based on designation to retrieve a result of determination on similarity/dissimilarity between the first mark and the second mark.
